(19) United States
(12) Patent Application Publication
(10) Pub. No.: US 2005/0056959 A1
(43) Pub. Date: Mar. 17, 2005

(54) Method for manufacturing color plates

(76) Inventor: Shyh Yuan Shyu, Tainan City (TW)

Correspondence Address: CHARLES E. BAXLEY, ESQUIRE;Third Floor, 90 John Street, New York, NY, 10038, US

(21) Appl. No.: 10/663,214

(22) Filed: Sep. 15, 2003

(51) Int. Cl. B29C 39/02; B29C 39/12; B29C 39/38; B29C 39/42

(52) U.S. Cl. 264/102; 264/331.15; 264/319; 264/250; 264/255

(57) ABSTRACT

A method for manufacturing color plates includes a mold device having a chamber formed between the panels and the gasket. One portion of the gasket forms an opening to fill a solution and one or more additive materials into the mold device. Air is removed from the solution by compressing the mold device. Dispose the mold device horizontally and preheat the mold device to harden the additive materials and the solution into a prototype, and to stably maintain the additive materials in position within the solution. One or more patterns and a polymer outer covering may further be applied onto the color plate to form a plate product.

### BACKGROUND OF THE INVENTION

1. Field of the Invention

The present invention relates to a method, and more particularly to a method for manufacturing color plates with glass mold devices.

2. Description of the Prior Art

Various kinds of typical methods have been developed and provided for manufacturing plates, floor and wall tiles or sheetings with synthetic materials, such as polyacrylic resin materials or the other copolymer materials.

For example, U.S. Pat. No. 3,663,493 to Miller and U.S. Pat. No. 4,053,442 to Jungr et al. disclose two of the typical methods for manufacturing plates, floor and wall tiles or sheetings with synthetic materials.

The typical plates, floor and wall tiles or sheetings have been disclosed to be manufactured with a molding method. However, the synthetic materials are normally formed or manufactured into the typical plates, floor and wall tiles or sheetings from a liquid or viscous state into the hardened status.

When additional particles or materials are introduced into the liquid or viscous synthetic materials, the additional particles or materials may have a tendency to flow or to move downwardly toward the bottom portion of the liquid or viscous synthetic materials that is contained within the mold device, such that the additional particles or materials may not be evenly distributed within the liquid or viscous synthetic materials contained within the mold device, before the liquid or viscous synthetic materials are hardened, and such that the typical sheeting forming method may not have additional particles or materials evenly distributed within the liquid or viscous synthetic materials.

The present invention has arisen to mitigate and/or obviate the afore-described disadvantages of the conventional method for manufacturing synthetic plates.

### SUMMARY OF THE INVENTION

The primary objective of the present invention is to provide a method for manufacturing color plates with glass mold devices, and for allowing colors and/or objects to be uniformly distributed within the glass mold devices.

In accordance with one aspect of the invention, there is provided a method for manufacturing color plates, the method comprising providing a mold device having spaced upper and bottom panels, and a gasket disposed between outer peripheral portions of the panels, to form a chamber between the panels and the gasket, disengaging a portion of the gasket from the panels, to form an opening between the panels, filling a solution into the chamber of the mold device via the opening of the mold device, the solution including resin material and polyvinyl chloride, filling additive materials into the chamber of the mold device via the opening of the mold device, and distributed within the solution, engaging the portion of the gasket into the panels, to enclose the opening of the mold device, removing air from the additive materials and the solution and from the mold device, preheating the mold device to harden the additive materials and the solution into a prototype, and to stably maintain the additive materials in position within the solution, and heating the mold device and the prototype to form the color plate. The mold device is supported horizontally to allow the additive materials to be suitably retained or maintained in the required position within the liquefied solution, and to be evenly distributed within the liquefied solution, before the liquefied solution and the additive materials are hardened into the hardened prototype.

After engaging the portion of the gasket into the panels, the mold device is horizontally disposed within a pressing machine to allow the additive materials to be maintained in position relative to the solution, and the mold device is then compressed with the pressing machine to remove the air from the additive materials and the solution and from the mold device.

Before compressing the mold device with the pressing machine, at least one pin is engaged into the upper panel and the gasket, to form at least one air passage between the upper panel and the gasket, and to allow the air to flow and to be removed from the additive materials and the solution and from the mold device via the air passage between the upper panel and the gasket.

Disengaging the pin from the upper panel and the gasket, to seal to the air passage between the upper panel and the gasket, after the air has been removed from the additive materials and the solution and the mold device.

Before preheating the mold device to harden the additive materials and the solution into the prototype, a hot water bath is provided, and the mold device is then engaged into the hot water bath which preheats the mold device to harden the additive materials and the solution into the prototype.

One or more patterns may further be provided and applied onto the color plate, and/or a polymer outer covering may further be applied onto the color plate to form a plate product.

The polymer outer covering and the color plate may be heated to melt and secure the polymer outer covering and the color plate together and to form the plate product. For example, the color plate may be disposed in a mold device, and the polymer outer covering is then filled or applied onto an outer peripheral portion of the color plate to form the plate product.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a cross sectional view illustrating a glass mold device for conducting the operating procedures of a method for manufacturing color plates in accordance with the present invention;

FIG. 2 is a perspective view illustrating a filling operation of the method for filling a primary solution into the glass mold device;

FIG. 3 is a perspective view similar to FIG. 2, illustrating a filling operation of the method for filling the plasticizer into the primary solution contained in the glass mold device;

FIG. 4 is a perspective view illustrating a compressing procedure of the method for comprising the primary solution and the plasticizer, and for removing air from the glass mold device;

FIG. 5 is a cross sectional view illustrating the compressing procedure for removing the air from the glass mold device;

FIG. 6 is a cross sectional view illustrating a preheating procedure for heating the materials retained within the glass mold device;

FIG. 7 is a cross sectional view illustrating a heating procedure for heating the materials retained within the glass mold device to form the color plate;

FIG. 8 is a plan view of the color plate;

FIG. 9 is a cross sectional view taken along lines 9-9 of FIG. 8;

FIG. 10 is a plan view illustrating a mold device for receiving the color plate;

FIG. 11 is a plan view of the color plate after being covered with a polymeriable material;

FIGS. 12, 13, 14 are cross sectional views taken along lines 12-12, 13-13, and 14-14 of FIG. 11 respectively; and

FIG. 15 is a perspective view showing the finally completed or manufactured color plate having the polymeriable material covered thereon.

### DETAILED DESCRIPTION OF THE PREFERRED EMBODIMENT

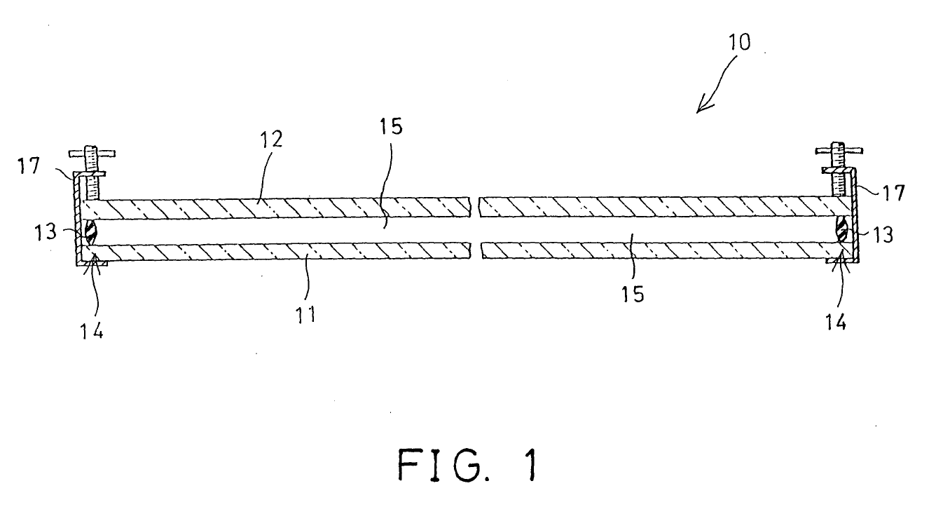

Referring to the drawings, and initially to FIG. 1, a method in accordance with the present invention is provided for manufacturing color plates with glass mold devices 10, and for allowing colors and/or objects to be uniformly distributed within the primary solution material contained within the glass mold devices 10.

The glass mold device 10 comprises two panels 11, 12, such as glass panels 11, 12 that are preferably disposed or arranged parallel to each other, and a spacer gasket 13 disposed between the outer peripheral portions 14 of the panels 11, 12, in order to form a planar space or chamber 15 between the panels 11, 12 and the spacer gasket 13.

A number of clamping devices 17 are then engaged onto the outer peripheral portions 14 of the panels 11, 12, as shown in FIGS. 1-4, in order to solidly clamp the spacer gasket 13 between the panels 11, 12, and so as to form the space or chamber 15 as an air-tight or a water-tight seal chamber 15.

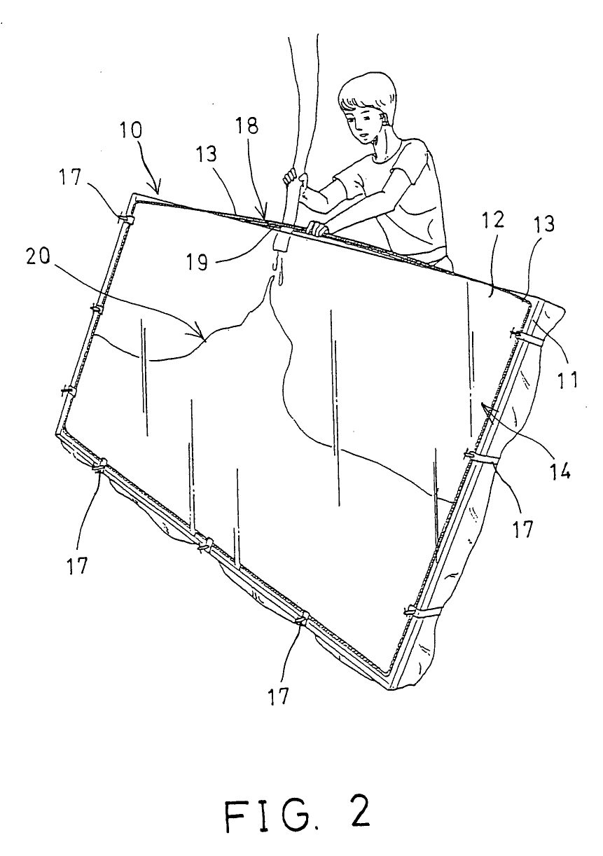

Referring next to FIG. 2, the mold device 10 is disposed in an erect or inclined attitude, and one portion, such as the upper portion 18 of the spacer gasket 13 is pulled or disengaged from the panels 11, 12, to form an opening 19 between the panels 11, 12, and to allow a liquefied solution 20 to be filled into the sealed chamber 15 of the mold device 10.

The liquefied solution 20 includes methacrylate resin and polyvinyl chloride which may include a proportion from such as 30:70 to 70:30, according to different requirements. The liquefied solution 20 is filled into the sealed chamber 15 of the mold device 10 via the opening 19 of the mold device 10, to occupy about 85-99.9% of the sealed chamber 15 of the mold device 10.

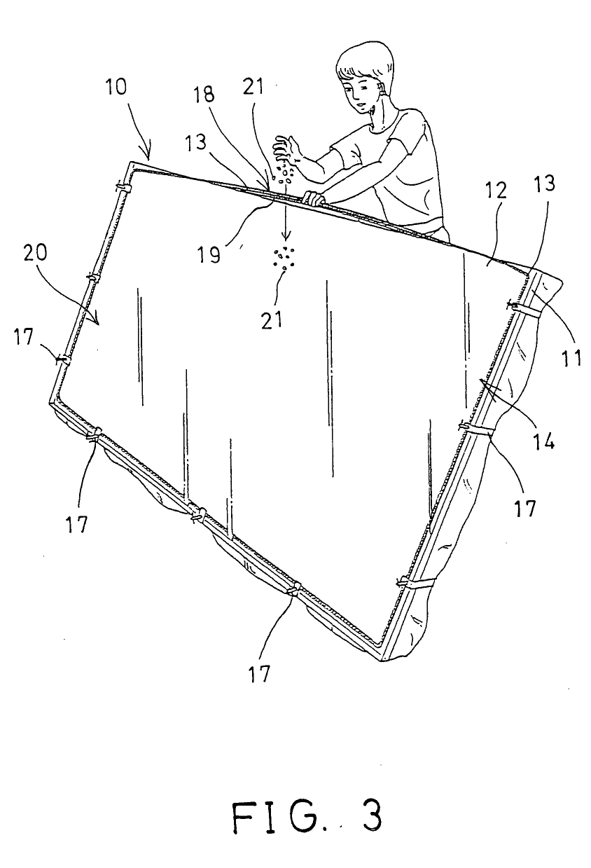

Referring next to FIG. 3, after the liquefied solution 20 has been filled into the sealed chamber 15 of the mold device 10, one or more additive materials 21 may then be filled into the sealed chamber 15 of the mold device 10 via the opening 19 of the mold device 10, and to be mixed and/or distributed within the liquefied solution 20.

The liquefied solution 20 and the additive materials 21 may include a proportion ranging from 0.1:99.9 to 15:85, according to different requirements. The additive materials 21 may include plasticizer, metal or shiny particles, paper materials, wood chips, cloth materials, etc., that are preferably evenly distributed within the liquefied solution 20, for decorative purposes or the like, in which the plasticizer is provided for plasticizing purposes.

After the additive materials 21 have been filled into and mixed with the liquefied solution 20, the upper portion 18 of the spacer gasket 13 is forced or engaged into the panels 11, 12 again, in order to enclose the opening 19 and the chamber 15 of the mold device 10 again, and so as to form the sealed chamber 15 of the mold device 10 again.

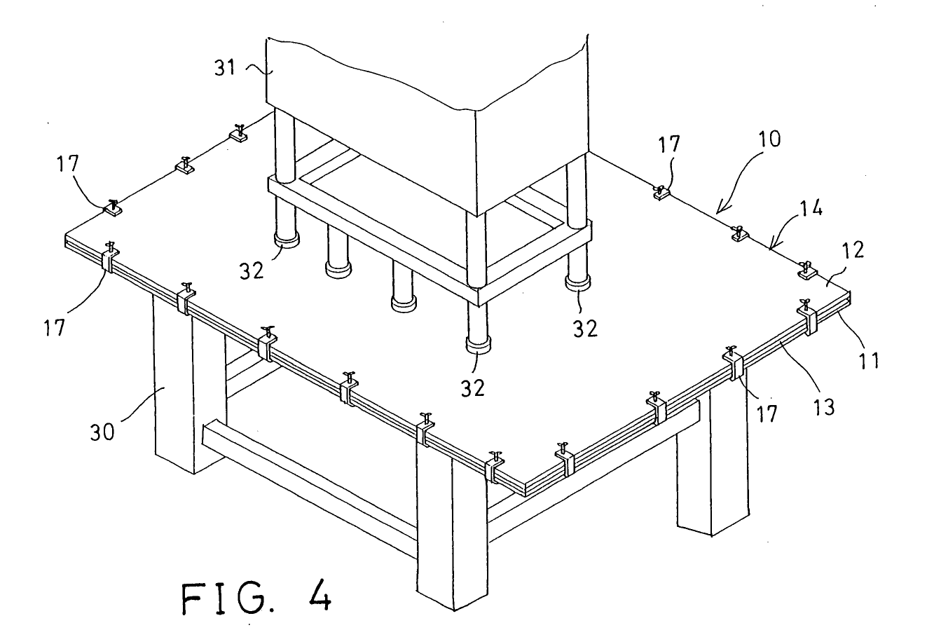

Referring next to FIG. 4, after the additive materials 21 have been filled into and mixed with the liquefied solution 20 and have been moved or arranged or distributed in suitable positions in the liquefied solution 20, the mold device 10 is disposed or supported horizontally on top of a base 30, and disposed below a pressing machine 31 which includes one or more presser feet 32 for depressing the mold device 10.

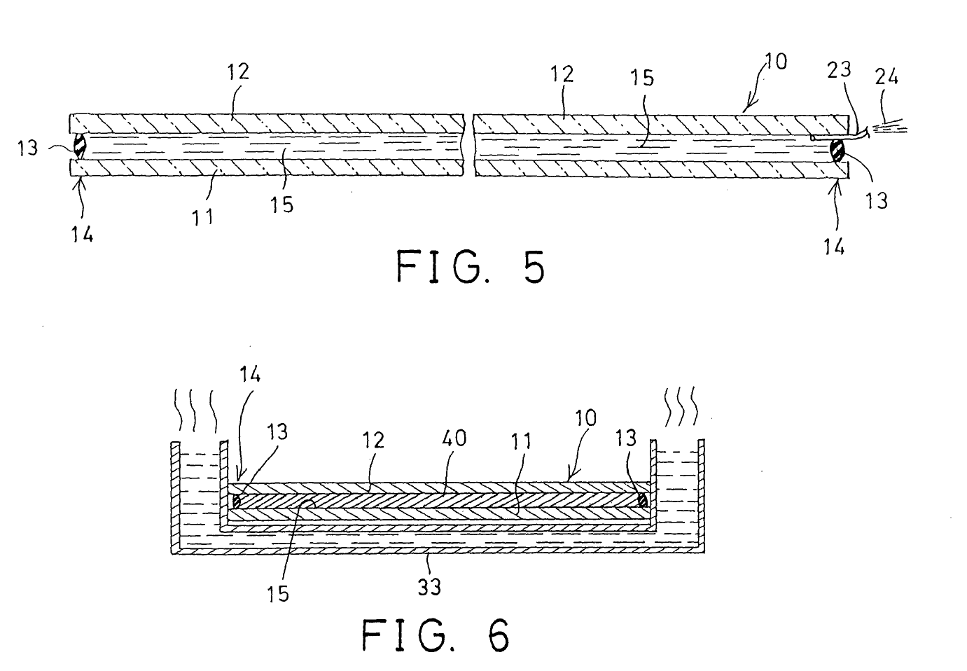

Referring next to FIG. 5, due to the horizontal arrangement of the mold device 10 on top of the base 30, the air or air bubbles that may be contained within the mold device 10 may flow upwardly toward the upper panel 12. One or more rods or pins 23 may be engaged between the gasket 13 and the upper panel 12, to form air passages between the gasket 13 and the upper panel 12, and to allow the air or the air bubbles 24 to be compressed or to be forced to flow out of the mold device 10 when the mold device 10 is compressed by the pressing machine 31.

The rods or pins 23 may be disengaged or removed from the gasket 13 and the upper panel 12, to seal the air passages formed between the gasket 13 and the upper panel 12, after the air or the air bubbles 24 have been compressed or forced to flow out of the mold device 10.

Referring next to FIG. 6, the mold device 10 is then disposed horizontally within a hot water bath 33, which may heat the liquefied solution 20 and the additive materials 21 contained within the mold device 10, in order to harden the liquefied solution 20 and the additive materials 21 into a hardened board or prototype 40 or the like.

It is to be noted that the mold device 10 is horizontally disposed within the hot water bath 33, such that the additive materials 21 may be suitably retained or maintained in the required position within the liquefied solution 20 and may be evenly distributed within the liquefied solution 20, before the liquefied solution 20 and the additive materials 21 are hardened into the hardened board or prototype 40.

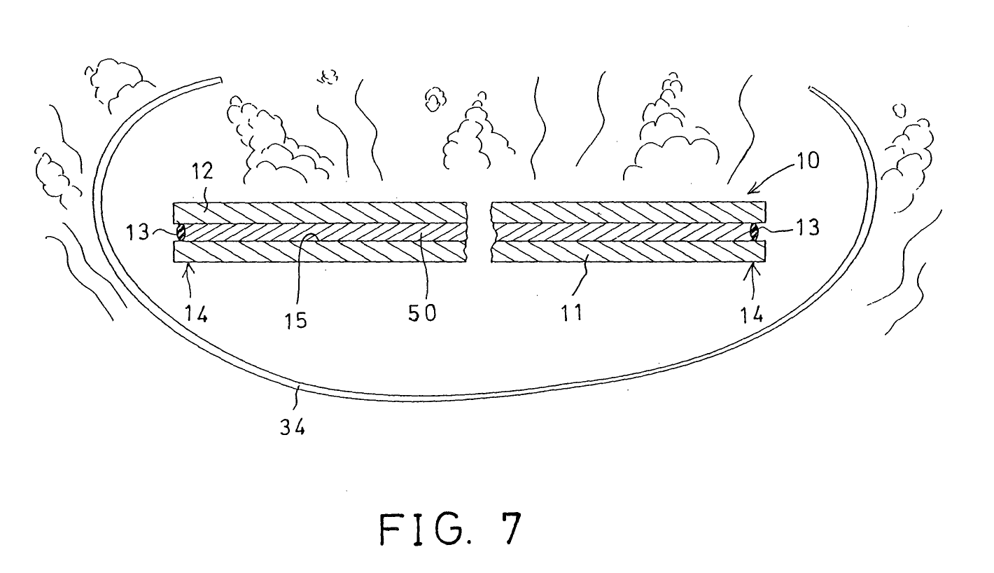

Referring next to FIG. 7, the mold device 10 is then disposed horizontally, but not necessarily be disposed horizontally within an oven 34, which may further heat the hardened board 40 into the required product: the hardened plate 50 or floor or wall tile or sheeting or the like.

It is to be noted that the additive materials 21 have been stably retained in the required position within the liquefied solution 20 after the liquefied solution 20 and the additive materials 21 have been hardened into the hardened board or prototype 40, such that the additive materials 21 will no longer be moved relative to the liquefied solution 20, and such that the mold device 10 and the hardened board or prototype 40 are not necessarily be disposed horizontally within the oven 34.

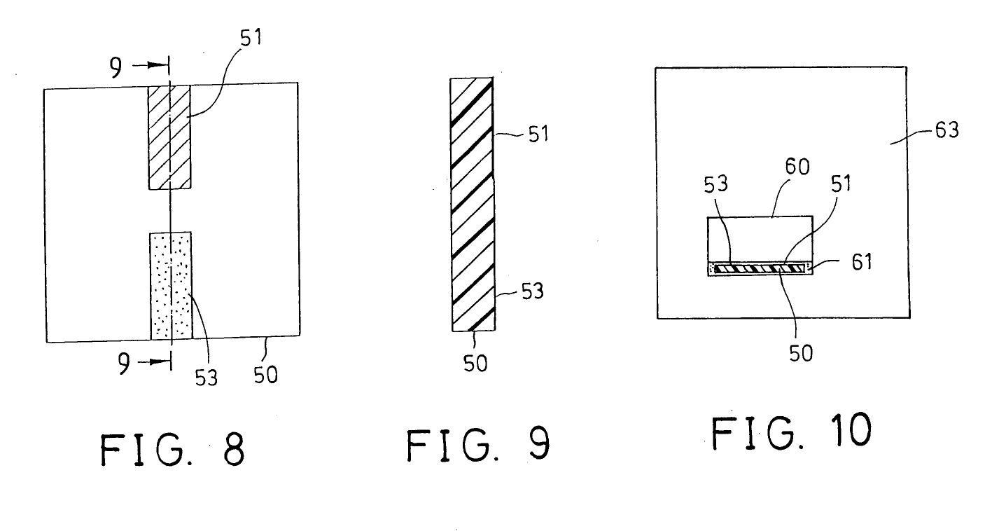

Referring next to FIGS. 8-10, the hardened plate 50 may further be applied with colors and/or patterns 51, 53 thereon with such as face printing method and/or face electroplating method, or face repraying method, or the like.

The hardened plate 50 may then be disposed in a mold device 60 (FIG. 10) for molding or applying or filling a polymeriable material (61) into the mold device 60 or onto the outer peripheral portion of the hardened plate 50, in order to form an outer covering 61 on the outer peripheral portion of the hardened plate 50. The polymeriable material may be selected from polyvinyl chloride materials, or acrylic materials, or the like.

The mold device 60 and the hardened plate 50 may then be disposed in a heating device or an oven 63, in order to melt and then secure the polymer outer covering 61 and the hardened plate 50 together. It is to be noted that the colors and/or patterns 51, 53 may separate the materials of the outer covering 61 and the hardened plate 50 from each other, and may thus prevent the materials at the area of the colors and/or patterns 51, 53 from being melted and secured together.

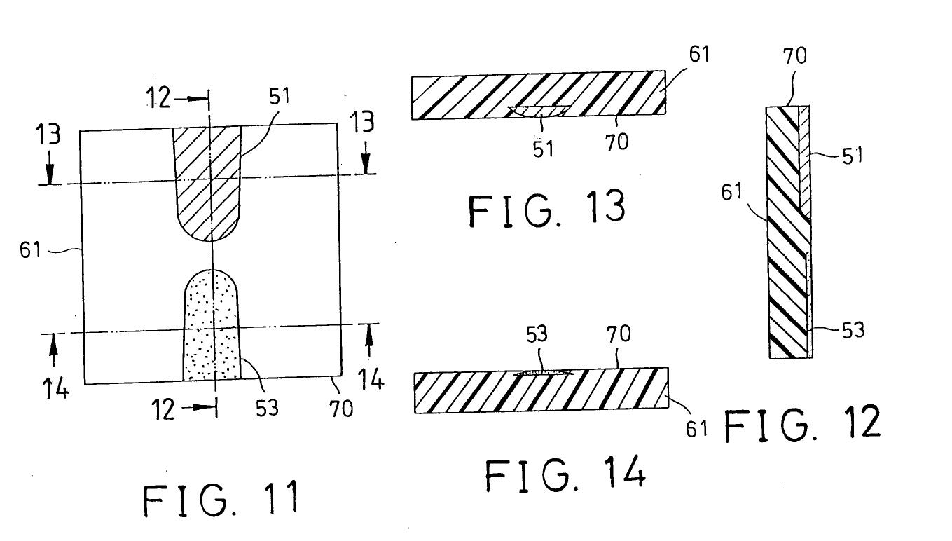

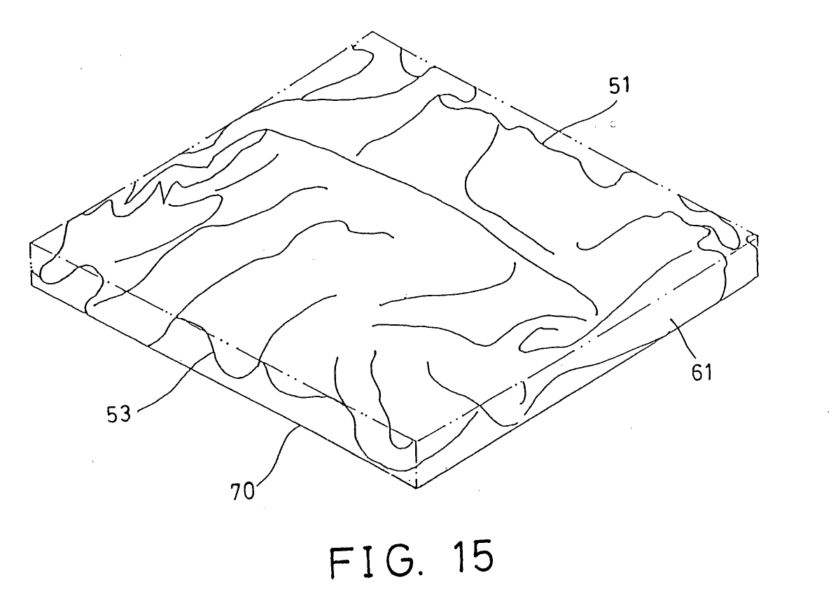

The other portions of the hardened plate 50 other than the area of the colors and/or patterns 51, 53 may thus be melted and secured together when the mold device 60 and the hardened plate 50 are heated by the heating device or the oven 63, in order to form the finally completed plate product 70 which has the polymeriable outer covering 61 provided or applied or covered thereon, as shown in FIGS. 11-15.

It is to be noted that the colors and/or patterns 51, 53 may be slightly distorted or changed to different or spatial patterns when the mold device 60 and the hardened plate 50 are heated by the heating device or the oven 63, such that the finally completed plate product 70 may have different or spatial patterns 51, 53 formed thereon.

Accordingly, the method may be used for manufacturing color plates with glass mold devices, and arranged to allow additive materials to be uniformly distributed within the solution received in the glass mold devices, and may have the polymeriable outer covering provided or covered thereon.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A method for manufacturing color plates, said method comprising:
providing a mold device having spaced upper and bottom panels, and a gasket disposed between outer peripheral portions of said panels, to form a chamber between said panels and said gasket,
disengaging a portion of said gasket from said panels, to form an opening between said panels,
filling a solution into said chamber of said mold device via said opening of said mold device, said solution including resin material and polyvinyl chloride,
filling additive materials into said chamber of said mold device via said opening of said mold device, and distributed within said solution,
engaging said portion of said gasket into said panels, to enclose said opening of said mold device,
removing air from said additive materials and said solution and from said mold device,
preheating said mold device to harden said additive materials and said solution into a prototype, and to stably maintain said additive materials in position within said solution, and
heating said mold device and said prototype to form said color plate.

2. The method as claimed in claim 1 further comprising, after engaging said portion of said gasket into said panels, horizontally disposing said mold device within a pressing machine to allow said additive materials to be maintained in position relative to said solution, and compressing said mold device with said pressing machine to remove the air from said additive materials and said solution and from said mold device.

3. The method as claimed in claim 2 further comprising, before compressing said mold device with said pressing machine, engaging at least one pin into said upper panel and said gasket, to form at least one air passage between said upper panel and said gasket, and to allow the air to flow and to be removed from said additive materials and said solution and from said mold device via said at least one air passage between said upper panel and said gasket.

4. The method as claimed in claim 3 further comprising disengaging said at least one pin from said upper panel and said gasket, to seal to said at least one air passage between said upper panel and said gasket, after the air has been removed from said additive materials and said solution and said mold device.

5. The method as claimed in claim 1 further comprising, before preheating said mold device to harden said additive materials and said solution into said prototype, providing a hot water bath, and engaging said mold device into said hot water bath which preheats said mold device to harden said additive materials and said solution into said prototype.

6. The method as claimed in claim 1 further comprising applying at least one pattern onto said color plate.

7. The method as claimed in claim 6 further comprising applying a polymer outer covering onto said color plate to form a plate product.

8. The method as claimed in claim 7 further comprising heating said polymer outer covering and said color plate, to melt and secure said polymer outer covering and said color plate together and to form said plate product.

9. The method as claimed in claim 7 further comprising disposing said color plate in a mold device, and applying said polymer outer covering onto an outer peripheral portion of said color plate to form said plate product.
